(19) United States
(12) Patent Application Publication
(10) Pub. No.: US 2012/0298018 A1
(43) Pub. Date: Nov. 29, 2012

(54) PORTABLE SAFE, SYSTEMS AND METHODS

(76) Inventor: Todd L. McCabe, Alpine, UT (US)

(21) Appl. No.: 13/479,000

(22) Filed: May 23, 2012

Related U.S. Application Data
(60) Provisional application No. 61/488,793, filed on May 23, 2011.
(60) Provisional application No. 61/488,792, filed on May 23, 2011.

(51) Int. Cl. E05G 1/04; E06B 7/16

(52) U.S. Cl. 109/51; 109/50

(57) ABSTRACT

A portable safe is configured to be temporarily secured to an object without requiring an individual who uses the portable safe to constantly monitor the portable safe or any valuable items secured therein. Thus, the individual may attend to other activities located nearby or remote from the object to which the portable safe is secured. An entity, such as a resort, a hotel or the like may make portable safes available for temporary use by its customers, enabling its customers to portably secure their valuable items. The supplier may rent the portable safes from another entity, which owns the portable safes.

### CROSS-REFERENCE TO RELATED APPLICATION

This application claims the benefit of priority under 35 U.S.C. §119(e) to U.S. Provisional Patent Application No. 61/488,793, filed May 23, 2011 and titled “Personal Portable Safe, Systems and Methods, pending, the entire disclosure of which is, by this reference, hereby incorporated herein.

### TECHNICAL FIELD

The subject matter disclosed and claimed by this application relates generally to portable safes or lock boxes and, more specifically, to portable safes and lock boxes that are configured to securely store valuable contents and to be secured retained at a desired location. The disclosed subject matter also relates to systems and methods by which portable safes are provided to individuals for temporary use.

### RELATED ART

Individuals often travel with valuable items that they may want to periodically access or use during certain activities, but that they may not want to constantly hold onto or keep track of throughout those activities. As an example, as an individual visits a location (e.g., an amusement park, a swimming pool, the beach, a ski resort, an athletic event, etc.), the individual may periodically want to use his or her camera, but may not want to worry about loss or theft of the camera when it is not in use. Accordingly, a variety of solutions have been developed that enable travelers to temporarily secure valuable items.

Lockers are one common solution for enabling an individual to secure valuable items in relatively close proximity to an individual as he or she enjoys various activities, making those valuable items accessible to the individual when access is desired. While lockers provide some peace of mind, they are typically fixed in relatively large banks to a particular location (e.g., a central location, such as a guest services counter, etc.), which may not be all that close to the individual's location when he or she decides to access a valuable item that has been secured in the locker. Although a locker may provide an individual with a sense of security, retrieving a valuable item from the locker may be somewhat burdensome, and may not provide the individual with ready access to the valuable item (e.g., when an individual wants to capture a moment on film, but it will take him or her several minutes to walk to the locker, retrieve the camera and walk back to the location where the event has occurred, etc.). Moreover, many lockers are of the pay-per-use type, which require that an individual deposit money each time he or she removes a key. Thus, if repeated access is desired, so is repeated payment. Further, locker keys are easily lost, making it even more difficult for an individual to retrieve his or her valuable items from the locker.

As another example, hotels often provide safes for their guests. The safes that are provided by hotels are usually fixed to the floor or to a wall of a hotel room. While hotel safes may enable guests to secure their valuable items within the room, they cannot provide any security for valuable items that the guest takes outside of the room. Thus, if a guest decides to take valuable items outside of his or her room (e.g., to a spa, to a gym, to a pool, to a beach, etc.), unless lockers are available outside of the room, the guest must constantly watch any valuable items he or she takes outside of the room, or risk losing those valuable items. Even when lockers are available at a location closer to the guest than his or her room, they may still not provide ready access to the guest's valuable items.

### SUMMARY

In one aspect, the present invention includes portable safes, or lock boxes, for securing valuable items. Such a portable safe includes a container, a door, at least one lock and a release mechanism. Additionally, a portable safe that incorporates teachings of the present invention includes an engagement element, or tether, and various features associated with the engagement element for selectively securing the container to another object.

The container, which includes a receptacle and an opening, carries various other elements of the portable safe. In particular, the container carries the door, which may be secured to the container by way of one or more hinges. The door may be placed in an open position to expose the opening and the receptacle, or it may be placed in a closed position over the opening. The container and the door may be configured to securely retain one or more valuable items within the receptacle, or the interior of the portable safe. In addition, the container and the door may be relatively light weight, contributing the portability of the portable safe. In some embodiments, one of both of the door may include a handle, which facilitates handling and/or transportation of the portable safe.

In some embodiments, an outer surface of the door may be configured complementarily to a base of the container. Without limitation, the outer surface of the door may include a recess configured to receive a complementarily configured portion of the base of the container of another, identical portable safe. Alternatively, the base of the container may include a recess configured to receive a complementarily configured portion of the outer surface of the door of another, identical portable safe. In such embodiments, the complementary configuration of the outer surface of the door and the base of the container may enable a number of identical portable safes to be securely stacked atop one another. The stability with which identical portable safes may be stacked may be further enhanced by additional cooperating features, such as complementary protrusions and indentations, magnets, or the like.

In addition to the door, the container may be configured to be engaged by the lock (e.g., it may include a receiver for the lock, etc.), or it may carry the lock and the release mechanism. Conversely, the door may carry the lock(s) and the release mechanism, or it may be configured to be engaged by the lock(s) (e.g., it may include a receiver for the lock, etc.). Each lock is configured to secure the door in place over the opening in the container.

In some embodiments, operation the lock may be controlled, or the lock may be opened or disengaged, by the release mechanism. The release mechanism selectively releases the lock(s) and, thus, the door from the container. When the door is positioned in a closed orientation over the opening of the container, the receptacle of the container and, optionally, any corresponding recess in an interior surface of the door define an interior of the portable safe.

The release mechanism may comprise a combination mechanism, which may release the lock or cause it to open when a proper combination, or code, of alpha-numeric characters (e.g., numbers, numbers and letters, letters, etc.) or other symbols is entered. The release mechanism may be configured to enable an individual to enter his or her own desired combination of easily remembered symbols. In some embodiments, the release mechanism may be configured to enable an individual to set an individualized combination when the portable safe is opened, and to use that combination when the individual wants to reopen the portable safe. In such an embodiment, the release mechanism may also be configured to open the lock when a master combination is entered. Alternatively, another, master release mechanism (e.g., a release mechanism that operates with a key, etc.) may also be associated with and control operation of the lock.

The engagement element may include an elongate element, such as a cable, that may be positioned around a portion of another object, to which the portable safe may be secured. A fixed end of such an engagement element may be permanently fixed to another portion of the portable safe, such as the container or the door. A removable end of such an engagement element may also be selectively secured to and removed from another portion of the portable safe (e.g., at a location adjacent to that from which the fixed end of the engagement element extends, a location somewhat remote from the location from which the fixed end of the engagement element extends, etc.), for example, at a correspondingly configured receptacle. When the removable end of the engagement element is coupled with another portion of the portable safe (e.g., with its corresponding receptacle, etc.), the door is closed over the opening of the container and the lock, in a locked position, secures the door in place, a retention element may engage and securely retain the removable end of the engagement element in position relative to the portable safe in a manner that prevents removal of the removable end from the portable safe. With the lock in an unlocked, or open or disengaged, position and, optionally, with the door of the portable safe open, the retention element may disengage and, thus, enable selective uncoupling of the removable end of the engagement element from the portable safe. Unlocking the lock, opening the door or actuation of a release element within the receptacle of the container and accessible through the opening of the container may cause the retention element to release the removable end of the engagement element and, thus, enable an individual to remove the removable end from the portable safe (e.g., from its corresponding receptacle, etc.).

According to another aspect, a portable safe that incorporates teachings of this disclosure may be provided to an individual, who may set the release mechanism of the portable safe with a personalized combination, or code. With a lock of the portable safe unlocked, or opened or disengaged, the individual may remove the removable end of an engagement element from the portable safe, position the engagement element around another object (e.g., a fixed structure; a large object, such as a chair or a lounge chair; etc.), and/or couple the removable end of the engagement element to the portable safe. In this manner, the engagement element may secure the portable safe at a relatively secure location. With the door of the portable safe open, valuable items (e.g., a camera, an electronic device, a wallet or purse, currency, bank cards, a hotel room key card, car keys, jewelry, etc.) may be placed within the receptacle of the container, and the container may be closed and locked to secure the valuable items therein. When the user desires to access his or her valuable items, he or she may simply operate the release mechanism (e.g., by entering a combination or code into the release mechanism, etc.) and open the door to access the items inside the receptacle of the container. With the door open and/or the lock unlocked, the releasable end of the engagement element may be released from the portable safe, and the engagement element and, thus, the portable safe removed from around the object to which the portable safe was secured.

In a more specific embodiment of a method of use, the present invention includes providing (e.g., renting, complimentary lending, etc.) an individual (e.g., a guest at a hotel, swimming pool, water park, beach, cruise ship, other resort, etc.) with a portable safe for use at a location where a number of other people may be present, and where the individual may need or want to participate in activities where his or her valuable items may be left behind (e.g., at a swimming pool, beach, cruise ship, resort, etc.). The individual may secure his or her valuable items within the portable safe, and secure the portable safe to a location where he or she will remember them (e.g., to a lounge chair, a chair, a table, a post or other fixture, etc.). The individual may then participate in activities away from his or her valuable items with some peace of mind that the valuable items will be safe from loss or theft. Once the individual is done using the portable safe, he or she may return the portable safe to the party from which it was obtained, and his or her personalized combination or code, if any, may be cleared. The portable safe may then be provided to another individual.

The party providing portable safes to its customers, which party may be referred to as the “supplier,” may itself be a customer of another party, or “owner,” that owns the portable safes. The owner may utilize any suitable type of financial arrangement with the supplier. In some embodiments, the owner may lease or rent the portable safes to the supplier, and the supplier may retain all revenues obtained from providing the portable safes to its customers. In other embodiments, the owner and the supplier may share in revenues generated as individuals rent the portable safes.

Other aspects, as well as features and advantages of various aspects, of the disclosed subject matter will become apparent to those of ordinary skill in the art through consideration of the ensuing description, the accompanying drawings and the appended claims.

### BRIEF DESCRIPTION OF THE DRAWINGS

In the drawings:

FIG. 1 is a perspective view of an embodiment of a portable safe, with a door of the portable safe in a closed position over a container of the portable safe;

FIG. 2 is a perspective view of the embodiment of portable safe of FIG. 1, with the door in an open position;

FIG. 3 provides a representation of various elements of the portable safe of FIG. 1 from the top of its container;

FIG. 4 illustrates an inner surface of the door of the portable safe shown in FIG. 1;

FIG. 5 is a top view of the portable safe shown in FIG. 1;

FIG. 6 is a bottom view of the portable safe shown in FIG. 1;

FIG. 7 is a side view of the embodiment of portable safe shown in FIG. 1, depicting an engagement element with its releasable end secured to another portion of the portable safe;

FIG. 8 is also a side view of the embodiment of portable safe shown in FIG. 1, illustrating the engagement element with its releasable end removed from the remainder of the portable safe;

FIG. 9 depicts a plurality of identical portable safes stacked relative to one another; and

FIG. 10 illustrates an example of a manner in which an embodiment of portable safe may be used.

### DETAILED DESCRIPTION

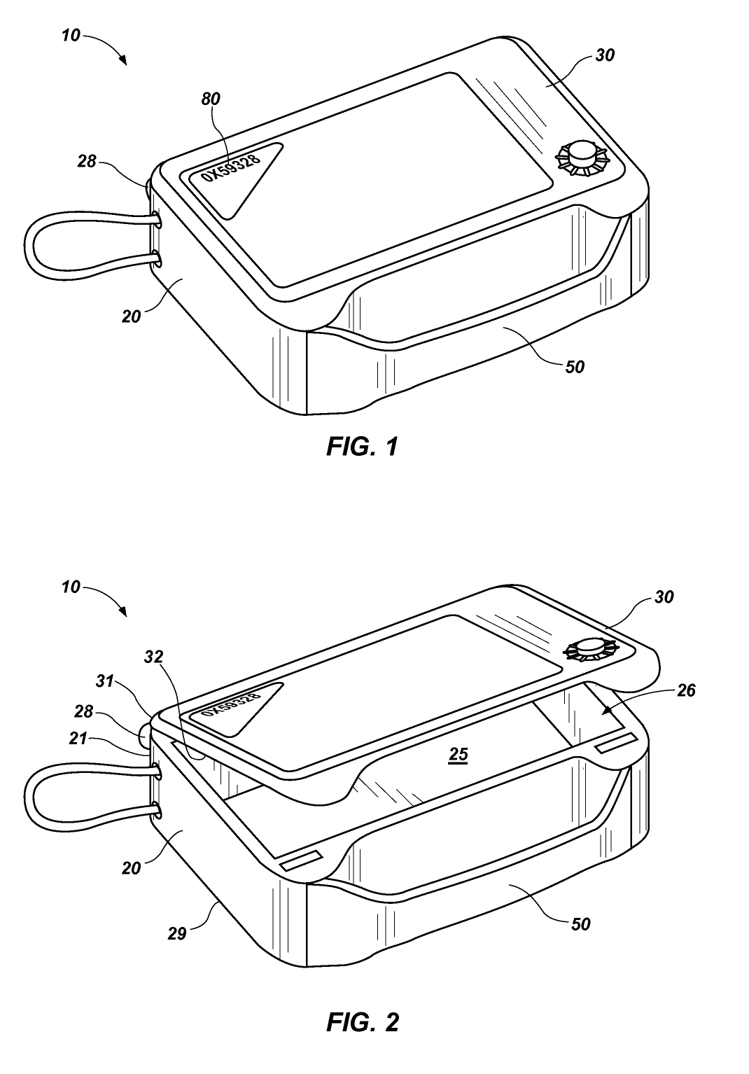

FIGS. 1 through 8 depict an embodiment of portable safe 10. As illustrated, the portable safe 10 includes container 20, a door 30, a release mechanism 40 and a handle 50, among a variety of other elements.

As shown in FIGS. 1 and 2, the door 30 of the portable safe 10 is configured to be assembled with the container 20 of the portable safe 10. More specifically, the door 30 may be placed in a closed position over the container 20, as shown in FIG. 1, or the door 30 may be at least partially spaced apart from the container 20 in an at least partially open position, a nonlimiting example of which is shown in FIG. 2. In the illustrated embodiment, one or more hinges 28 at corresponding edges 21 and 31 of the container 20 and the door 30, respectively, may secure the edge 31 of the door 30 to its corresponding edge 21 of the container 20 and guide movement of the door 30 between its closed position and its open position. With the door 30 in the open position, an inner surface 32 of the door 30, a receptacle 25 within the container 20 and an opening 26 to the receptacle 25 may be exposed.

One or both of the door 30 and the container 20 may be configured to seal against the other when the door 30 is in its closed position. In some embodiments, the inner surface 32 of the door 30 and the receptacle 25 may include (e.g., be lined with, be formed from, etc.) a somewhat compressible, resilient material, water impermeable material (e.g., a synthetic rubber, etc.) that enables cooperating edges of these features to seal against each other. In such embodiments, when the door 30 is closed, the receptacle 25 may be sealed, preventing water from reaching the receptacle 25 and its contents. Additionally, sealing the receptacle 25 may impart the portable safe 10 with some buoyancy.

Additional buoyancy may be provided by way of materials, or buoyant elements, that provide air pockets within the walls of the portable safe 10. As a nonlimiting example, inner surfaces of the walls of the portable safe 10 (e.g., its container 20, its door 30, etc.) may be lined with porous materials. The porous materials may include closed cells. Alternatively, in embodiments where the buoyant elements are sealed within the walls of the portable safe 10, they may include open cells. In some embodiments, the buoyancy of the portable safe 10 may enable the portable safe 10 to float in water.

The outer surfaces of the portable safe 10 (e.g., of its container 20, its door 30, etc.) may comprise relatively rugged, impact-resistant, scratch-resistant materials. In addition, the material(s) from which the exterior of the portable safe 10 is (are) formed may resist damage from liquids (e.g., water, solvents, beverages, etc.), and may be easily cleaned. Further, the materials from which the outer surfaces of the portable safe 10 are formed may enable the portable safe 10 to securely retain one or more valuable items while providing the portable safe 10 with a desired appearance.

In a specific embodiment, a portable safe 10 that incorporates teachings of this disclosure may have a width of about 12 inches, a height of about 8¾ inches and a depth of about 3½ inches. Such a portable safe 10 may weigh about two pounds or less.

The handle 50 shown in FIGS. 1 and 2, may enhance the portability of the portable safe 10. In some embodiments, the handle 50 which may be configured to protrude somewhat from a side of the container 20 of the portable safe 10. For example, as shown, the handle 50 may be fixed in position relative to the container 20, and protrude somewhat form the container 20. More specifically, the handle 50 may protrude from a side of the container 20 opposite from that with which the hinge(s) 28 is (are) associated. In such an embodiment, the handle may be configured (e.g., positioned, shaped, have a weight, etc.) such that a center of gravity of the container 20 is located closer to the handle 50 than to the opposite side of the container 20, providing a counterbalance to door 30 when placed in its open position, as shown in FIG. 2. Thus, a base 29 of the container 20 may support the portable safe 10 regardless of whether the door 30 is in its closed position or its open position.

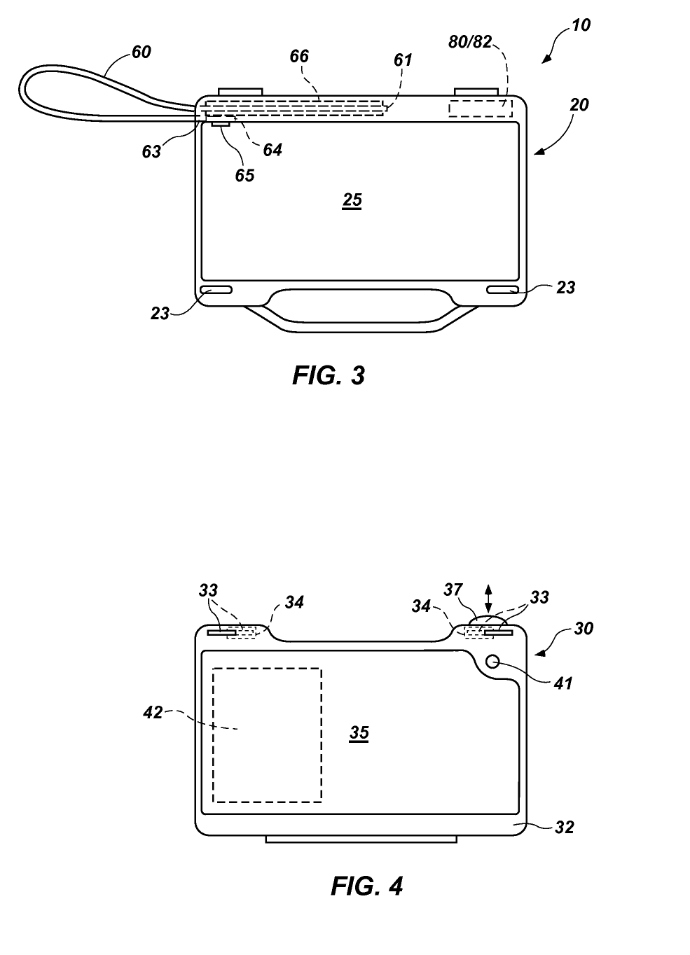

FIGS. 3 and 4 illustrates several elements of the portable safe 10 that are exposed when the door 30 is in its open position and its inner surface 32 and the receptacle 25 of the container 20 are exposed. Referring first to FIG. 4, in some embodiments, the door 30 may carry a lock 33, which may be configured for movement between a disengaged position, shown in phantom, and an engaged position, shown in solid lines. In some embodiments, such as that depicted by FIG. 4, when the lock 33 is its disengaged position, it may be at least partially retracted within a corresponding receptacle 34 that opens to a surface of the door 30, such as the interior surface 32, as depicted, or to an edge of the door 30. Also in such embodiments, when the lock 33 is in its engaged position, it may extend out of the receptacle 34 and protrude from the door 30. With the lock 33 in the engaged position and the door 30 closed over the container 20, the lock 33 may extend into and engage a corresponding receiver 23 in the container 20, which is shown in FIG. 3. Of course, the positions of the lock 33 and its receiver 23 may be reversed.

In addition to a lock 33 (or a receiver 23 for a lock 33), a recess 35 in the inner surface 32 of the door 30 may align and communicate with the receptacle 25 of the container 20, effectively increasing a volume of the receptacle 25 when the door 30 is in the closed position over the container 20.

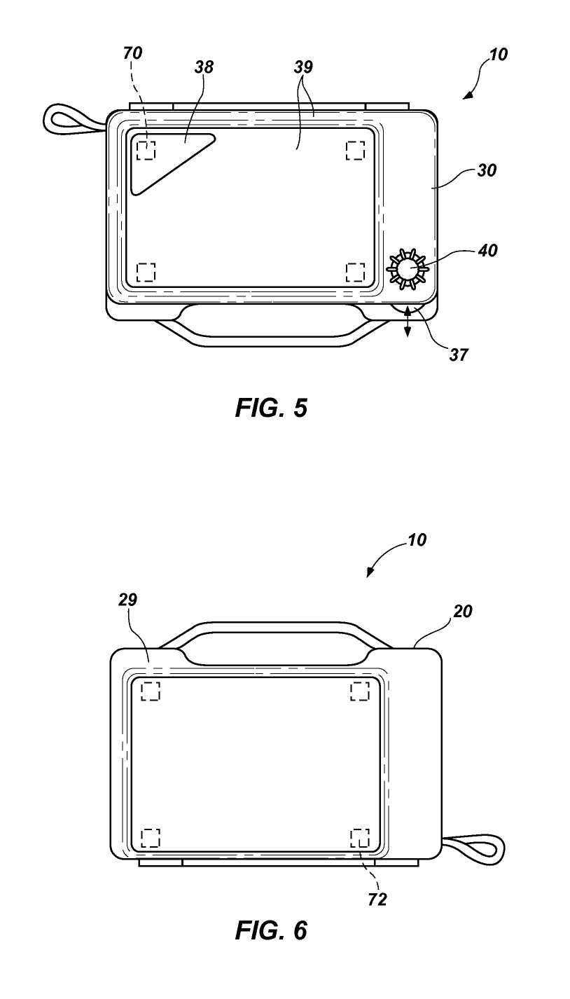

On its other side—i.e., the outer surface 39 of the door 30, as illustrated by FIG. 5, an exterior portion of the release mechanism 40 may be exposed. In addition to the exterior portion, the release mechanism 40 may include an interior portion (not shown), which is operably associated with the lock 33 (FIG. 4). The release mechanism 40 may comprise any suitable type of release mechanism known in the art. Without limitation, the release mechanism 40 may comprise a mechanical actuator, such as a rotary combination mechanism (i.e., a combination lock) of known type, a conventional key actuator or the like. Alternatively, the release mechanism may comprise an electronic release mechanism (e.g., a digital combination mechanism; a biometric mechanism, such as a fingerprint recognition element; an electronic card reader, a radiofrequency (RF) sensor, etc.). Of course, other embodiments of release mechanisms 40 may also be included as part of a portable safe 10.

In various embodiments, the release mechanism 40 may include a reset feature 41, which is shown in FIG. 4, and which enables an individual to individualize a combination or code that opens the release mechanism 40 (e.g., input his or her own combination, etc.). The reset feature 41 may comprise a button on the inner surface 32 of the door 30. The inner surface 32 of the door 30 may also carry printed instructions 42 for using the reset feature 41, as well as for using other features of the portable safe 10.

In addition to releasing a lock 33, a release mechanism 40 may be configured to actuate an indicator 37, which may provide an individual with a readily discernable visual indicator of a state of the release mechanism 40 and/or of a lock 33 with which the release mechanism 40 is associated. In some embodiments, such as that depicted by FIGS. 4 and 5, the indicator 37 may comprise a mechanically actuated element, such as a feature that extends from and may be retracted into the release mechanism 40 or from any other feature of the portable safe 10. In other embodiments, the indicator 37 may comprise an electronic element, such as a light-emitting diode (LED) or the like.

The outer surface 39 of the door 30 may also include one or more indica 38. As depicted by FIG. 5, such indicia 38 may include branding by an entity (e.g., a hotel, resort, other facility, etc.) that provides the portable safe 10 to an individual. In addition, the door 30 may carry an indicia 38 that distinguishes the portable safe 10 (FIGS. 1 and 2) from other similar or identical portable safes (e.g., an alpha-numeric identifier, another symbol, etc.).

Turning again to FIG. 3, in some embodiments, the container 20 of the portable safe 10 (FIGS. 1 and 2) may, in addition to including the receptacle 25, carry a variety of other elements of the portable safe 10. For example, the container 20 may carry at least a portion of an engagement element 60. More specifically, a fixed end 61 of the engagement element 60 may be secured in placed relative to the container 20. The container 20 may also carry a retainer 64 for releasably receiving an opposite, releasable end 63 of the engagement element 60.

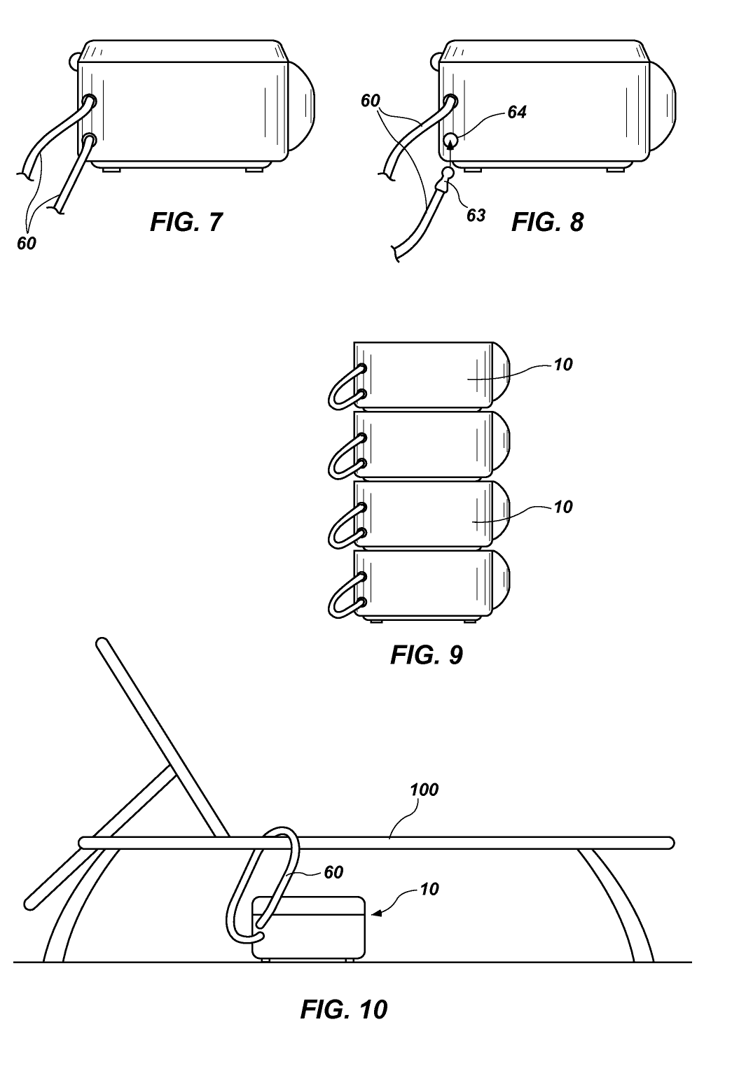

In a specific embodiment, which is illustrated by FIG. 3, as well as by FIGS. 7 and 8, the engagement element 60 may comprise an elongate element. Non-limiting examples of such an engagement element 60 include flexible members, such as woven metal cables, a pivotable U-shaped elements or other elements that may be securely disposed around another object 100 to secure the portable safe 10 in place relative to that object 100, as illustrated by FIG. 10.

With returned reference to FIG. 3, in embodiments where the engagement element 60 is flexible (e.g., it comprises a cable, etc.), a retraction element 66 may be associated with the engagement element 60. The retraction element 66 may be carried by the container, for example, within a concealed compartment 27 of the container 20, with the fixed end 61 of the engagement element 60 secured to the retraction element 66. The retraction element 66 may be configured to take up slack in the engagement element 60 (e.g., it may comprise a spring-loaded reel, etc.). In such an embodiment, the engagement element 60 may be extended from the container or taken back into the container 20 through a port 62 extending through a wall of the container 20.

The opposite end of such an engagement element 60; i.e., its releasable end 63, when engaged by (e.g., introduced into, etc.) its complementary retainer 64, may be held in place until the retainer 64 releases the releasable end 63. The retainer 64 may be actuated, or configured to disengage the releasable end 63 of the engagement element 60 manually or automatically, A retainer 64 may be manually actuated by way of a manually operable actuator 65 (e.g., a button, switch, lever, etc.) accessible from within the receptacle 25 of the container 20. Alternatively, an actuator 65 may be associated with the release mechanism 40, the lock 33 (FIGS. 1, 2, 4) or the door 30 (FIGS. 1, 2, 4) (e.g., as it opens and closes) to automatically cause the retainer 64 to move between a disengaged position, in which it may release the releasable end 63 of the engagement element 60 (as shown in FIG. 8), and an engaged position, in which it may engage the releasable end 63 (as shown in FIG. 7).

Of course, instead of being carried by or otherwise associated with the container 20, one or more of the engagement element 60 and the features associated therewith may be carried by or otherwise associated with another element of the portable safe 10, such as the door 30 or the handle 50.

The portable safe 10 may also include an identification element 80 (see also, FIG. 1) and/or a location element 82. A bar code, a serial number, an RFID (radiofrequency identification) device, or any other suitable identifier may serve as an identification element 80. A location element 82 may comprise a signal transmitting RFID device, a GPS (global positioning system) tracking device, or any other suitable tracking device, as well as an associated power source (e.g., a battery, a solar power cell, etc.). The location element 82 may be configured to enable the individual or another party (e.g., a party from which the individual temporarily obtains the portable safe 10, etc.) to determine the current location of the portable safe 10.

With reference to FIGS. 5 and 6, complementary stabilization features 70 and 72 may be formed in the outer surface 39 of the door 30 (FIG. 4) and in the base 29 of the container 20 (FIG. 6). In some embodiments, the stabilization features 70 and 72 may comprise a magnetic material and/or a material that is attracted to a magnetic field, and may be positioned and oriented for mutual attraction. In the example of magnetic or magnetically attractable stabilization features 70 and 72, each stabilization feature 70 at or near the outer surface 39 of the door 30 may configured to attract or be attracted to a corresponding stabilization feature 72 at or near the base 29 of the container 20. As an alternative to magnetic stabilization feature 70 and 72, stabilization features 70 and 72 may be configured to mechanically mate with one another (e.g., they may comprise complementarily configured protrusions and indentations, etc.). One or both of the complementarity of any the stabilization features 70 and 72 of a portable safe 10 and a complementary configuration between the outer surface 39 of the door 30 (FIG. 5; e.g., a shallow recess, etc.) of one portable safe 10 and the base 29 of the container 20 (FIG. 6; e.g., a slightly protruding surface, etc.) of another portable safe 10 may facilitate stable stacking of a number of identically or similarly configured portable safes 10, such as in the manner shown in FIG. 9.

Referring collectively to FIGS. 1 through 9, examples of use of various features of the portable safe 10 are described.

In use, a portable safe 10 may be provided to an individual with the lock 33 unlocked and, optionally, the door 30 in its open position. With the door 30 open, the individual may set the release mechanism 40, for example, with a personalized combination or code.

In addition, while the lock 33 is unlocked and/or the door 30 is open, the individual may cause the retainer 64 to release the releasable end 63 of the engagement element 60. With the releasable end 63 of the engagement element 60 free, the individual may position the engagement element 60 around another object 100 then, with the engagement element 60 still around the object 100, cause the retainer 64 to reengage the releaseable element 63, securing the portable safe 10 in place relative to the object 100.

With the door 30 of the portable safe 10 open and the receptacle 25 of the container 20 exposed, one or more valuable items may be positioned within the receptacle 25. The door 30 may then be closed and the lock 33 engaged to secure the valuable item(s) within the receptacle 25. With the portable safe 10 secured to another object 100 and locked, the individual whose valuable items are secured within the portable safe 10 may attend to other activities with the assurance that measures have been taken to prevent the loss or theft of his or her valuables.

When the individual needs to access valuable items that have been secured within the portable safe 10, he or she may use the release mechanism 40 to unlock the lock 33, open the door 30, and retrieve the desired item(s) from the receptacle 25. Thereafter, the contents of the receptacle 25 may be resecured until further access is desired by closing the door 30 and locking the lock 33.

If the individual decides to participate in activities at another location, he or she may open the portable safe 10, remove the engagement element 60 from the object 100, transport the portable safe 10 to the new location and secure the portable safe 10 to another object 100. In this manner, the individual may keep the portable safe 10 and the valuable items therein close by, enabling the individual to readily access the valuable items without constantly carrying them or keeping an eye on them.

An individual may temporarily obtain a portable safe 10 as he or she visits a location where the portable safe will be used. As an example, the individual may rent the portable safe 10 or the portable safe 10 may be complimentarily provided to the individual as part of his or her visit to that location (e.g., as part of a resort fee, room charge, etc.).

In some embodiments, the party that provides portable safes 10 to its guests (a “supplier”) may rent the portable safes from another party, which owns the portable safes 10 (an “owner”). The rental fees for the portable safes 10 may be determined in a number of different ways. For example, the supplier may pay the owner a fixed periodic (e.g., monthly, quarterly, etc.) fee for each portable safe 10, or for a fixed number of portable safes 10. As a more specific example, a supplier may rent a number of portable safes 10 at a per-safe rate of twenty dollars each month. In another example, the supplier may pay the owner a portion of the revenues obtained from renting the portable safes 10 to customers. Such rental arrangements may enable the supplier to avoid capital expenditures and other risks associated with ownership of a large number of portable safes 10, while potentially providing the supplier with a pecuniary benefit.

The supplier may provide portable safes 10 to its guests or other customers. In some embodiments, the supplier may profit from those individuals' use of the portable safes 10, or at least recoup some of its expenses associated with making the portable safes 10 available to its customers, by charging its customers to use the portable safes 10. Without limitation, the supplier may charge its customers a fixed fee for use of the portable safe 10 over a fixed period of time (e.g., daily, weekly, etc.). As an example, a supplier may rent a portable safe 10 at a daily rate of ten dollars or a discounted weekly rate of fifty dollars. As yet another example, a supplier may simply provide its customers with access to a portable safe 10 upon request (e.g., complimentarily, as part of another fee, etc.).

Since the portable safes 10 may inherently be moved from one location to another, in embodiments where the portable safes 10 are provided by a supplier to its guests or other customers, it may be desirable, or even necessary, to ensure that an individual who uses the portable safe 10 will return it. In some embodiments, such assurances may be provided merely by tying an identity of the individual who will be temporarily responsible for the portable safe 10 to a unique identifier for the portable safe 10 and requiring that some form of monetary security be provided (e.g., a bank card number, a deposit, etc.) by the responsible individual.

Alternatively, or in addition, the locations of the portable safes 10 may be tracked to provide additional assurances that they may be recovered. As noted previously herein, each portable safe 10 may be provided with a location element 82. The location element 82 of one portable safe 10 may be readily distinguishable from the location elements 82 of other portable safes 10, enabling a supplier to identify the individual responsible for each portable safe 10. When used in conjunction with a tracking system suitable for use with the locations elements 82, the supplier may remotely track the location of each portable safe 10 that has been provided to the suppliers customers.

Although the foregoing description contains many specifics, it should not be construed as limiting the scope of the invention or of any of the appended claims, but merely as providing information pertinent to some specific embodiments that may fall within the scopes of the appended claims and of the legal equivalents to the elements of the appended claims. Other embodiments of the invention may also be devised which lie within the scopes of the appended claims and of the legal equivalents to the elements of the appended claims. Features from different embodiments may also be employed in combination. All additions, deletions and modifications, as disclosed herein, that fall within the scopes of the claims are to be embraced thereby.

What is claimed:

1. A portable safe, comprising:
a container including an receptacle and an opening;
a door configured to be positioned over the opening of the container;
a lock for securing the door in place over the opening of the container;
a release mechanism for unlocking and locking the lock; and
an engagement element for tethering and temporarily securing the container to a separate object in proximity to a user of the portable safe.

2. The portable safe of claim 1, wherein the at least one release mechanism comprises a combination mechanism.

3. The portable safe of claim 2, wherein the combination mechanism is configured to be set with an individualized combination or code.

4. The portable safe of claim 1, wherein the engagement element is configured to be positioned around or removed from the separate object when the door is in an open position and to be secured to the separate object when the door is in the closed position.

5. The portable safe of claim 1, comprising an actuator accessible only when the door is in an open position, the actuator configured to release an end of the engagement element.

6. The portable safe of claim 1, wherein the engagement element wherein the element comprises a cable.

7. The portable safe of claim 1, wherein the door closes over the opening of the container in a manner that provides a watertight seal.

8. The portable safe of claim 1, wherein at least one of the container and the door are configured to impart the portable safe with buoyancy.

9. The portable safe of claim 1, further comprising:
a location element to enable remote location of the portable safe with a tracking system.

10. The portable safe of claim 1, wherein an outer surface of the door and a base of the container are configured complementarily to one another to enable the portable safe to be stacked with an identically configured portable safe.

11. The portable safe of claim 10, further comprising:
at least one stabilization feature associated with the outer surface of the door; and
at least another stabilization feature associated with the base of the container,
the at least one stabilization feature and the at least another stabilization feature being configured to cooperate with one another such that, when the portable safe is stacked with another identically configured portable safe, the at least one stabilization feature of one portable safe cooperates with and engages the at least another stabilization feature of an adjacent portable safe.

12. The portable safe of claim 11, wherein the at least one stabilization feature and the at least another stabilization feature are configured to be magnetically attracted to one another.

13. A system for providing customers with security for their valuable items, comprising:
a plurality of portable safes, each portable safe of the plurality of portable safes including:
an engagement element configured to be removably secured to another object; and
an identifier to distinguish the portable safe from other portable safes of the plurality of portable safes.

14. The system of claim 13, further comprising:
a tracking system,
wherein each portable safe further includes:
a location element configured to be tracked by the tracking system.

15. The system of claim 13, wherein the plurality of portable safes are configured to be stacked, one atop another.

16. The system of claim 15, wherein each portable safe of the plurality of portable safes further includes:
stabilization features in opposite surfaces that are configured to align and engage corresponding stabilization features of an adjacent portable safe of the plurality of portable safes with the portable safe and the adjacent portable safe are stacked.

17. A method for protecting an individual's valuable items, comprising:
providing an individual with a portable safe;
providing the individual with an instruction on setting at least one release mechanism on the portable safe with an individualized combination or code;
providing the individual with an instruction on securing the portable safe to a non-portable object with an engagement element; and
providing the individual with an instruction on locking a container of the portable safe.

18. An open environment in which one or more items may be secured and left, comprising:
an open environment that may be occupied by a plurality of people;
at least one non-portable object in the open environment; and
at least one portable safe including an engagement element securable to the at least one non-portable object to enable an individual using the at least one portable safe to leave the at least one non-portable object while the at least one portable safe and at least one valuable item secured by the at least one portable safe remain at the non-portable object.

19. The open environment of claim 18, comprising a swimming pool, water park, beach, cruise ship, or other resort and the at least one non-portable object comprises at least one of a lounge chair, a chair and a table.

20. A system for providing portable safes to individuals, comprising:
an owner of a plurality of portable safes;
a supplier who rents the plurality of portable safes from the owner and provides a supply location from which the plurality of portable safes are made available to individual customers of the supplier; and
individual customers of the supplier each of whom temporarily obtain a portable safe from the supplier at the supply location for use at one or more locations remote from the supply location.
